(19) United States
(12) Patent Application Publication
(10) Pub. No.: US 2017/0322808 A1
(43) Pub. Date: Nov. 9, 2017

(54) LOW-POWER PROCESSOR WITH SUPPORT FOR MULTIPLE PRECISION MODES

(71) Applicant: Cirrus Logic International Semiconductor Ltd., Edinburgh (GB)

(72) Inventors: Anthony James Magrath, Edinburgh (GB); Bryant E. Sorensen, Austin, TX (US)

(73) Assignee: Cirrus Logic International Semiconductor Ltd., Edinburgh (GB)

(21) Appl. No.: 15/147,642

(22) Filed: May 5, 2016

(51) Int. Cl. G06F 9/30

(52) U.S. Cl. CPC G06F 9/30112; G06F 9/3001; G06F 9/30189

(57) ABSTRACT

Multiple data wordlengths may be supported by a processor through a single data path and/or a single set of registers. For example, the processor may support 16-bit wordlengths and 24-bit wordlengths through a single datapath. For supported data wordlengths that are less than the wordlength of the registers and datapath, the data may be left-aligned within the registers and datapath. The left alignment of data may allow saturation detection in the processor to be performed by examining the same saturation point regardless of the wordlength of the data being operated on. A special saturation mode of the processor may set the lower bits to zero when a configuration register or instruction-bit is set and saturation is detected.

### FIELD OF THE DISCLOSURE

The instant disclosure relates to processors. More specifically, portions of this disclosure relate to supporting multiple modes of operation within a processor.

### BACKGROUND

It is often desirable for a processor to support multiple data wordlengths. For example, when 16-bit processors were released, it was desirable for the 16-bit processor to also be able to operate on 8-bit data. Likewise, when 32-bit processors were released, it was desirable for the 32-bit processor to be able to operate on 16-bit data. However, these processors were desktop processors with generally no power constraints and no size constraints. Thus, solutions for supporting multiple wordlengths described below that may be implemented, for example, in desktop processors, are not ideal for mobile applications.

One conventional solution for supporting multiple data wordlengths is to have separate datapaths for each of the possible wordlengths. For example, when there are two possible wordlengths of 16-bit and 24-bit, two datapaths may be constructed in the physical processor and each datapath activated when data of its wordlength is processed. FIG. 1 is an example digital signal processor for processing data with different word lengths through two different data paths according to the prior art. A processor 100 may include registers 102 coupled to two separate datapaths 104 and 106 for reading and writing data from and to the registers 102. Each of the datapaths 104 and 106 may include circuitry 104A and 106A, respectively, for processing data. In the processor 100, when operating in 24-bit mode the datapath 104 is active and processing data in circuitry 104A while the datapath 106 is disabled, and when operating in 16-bit mode the datapath 106 is active and processing data in circuitry 106A while the datapath 104 is disabled. The processor 100 is simple to implement and construct because of the separate datapaths. However, the datapaths in the processor 100 may occupy twice as much or more die area than a single datapath alone. This increase in die area increases fabrication complexity, increases cost, and makes integration of the processor 100 into mobile devices difficult. Additionally, logic (not shown in FIG. 1) is required to switch between the two datapaths 104 and 106, and that logic increases power consumption of and reduces possible operating speed of the processor 100. Further, implementation of more than two operating modes involves addition of more datapaths, further increasing size and cost of the processor.

Another conventional solution is to configure a processor with a single datapath having different operational modes to switch between different wordlengths. FIG. 2 is an example digital signal processor for processing data with different word lengths through a configurable data path according to the prior art. A processor 200 may include registers 202 coupled to a configurable datapath 204 and to circuitry 204A for reading data from the registers 202, processing the data, and writing data back to the registers 202. The datapath 204 may be split into a 16-bit portion and an 8-bit portion, such that the datapath 204 may be configured to operate in either 16-bit mode (by operating using the 16-bit portion) or 24-bit mode (by operating using the 16-bit portion and the 8-bit portion). Die area occupied by processor 200 is reduced in comparison to the separate datapaths of processor 100 of FIG. 1. However, logic is required to switch the datapath 204 between operating modes. This logic increases the die area of, and thus cost of, processor 200 and reduces possible operating speed of the processor 200.

Both of the conventional solutions described above with reference to FIG. 1 and FIG. 2 further require a scheme for storing the different wordlength data. Conventional solutions to this problem are to include circuitry for combining data of different wordlengths into the registers or including a separate register for each supported data wordlength. Both of these solutions still further increase the required circuitry in processors and thus increases the die area, increases the cost, and increases power consumption. These solutions may be disadvantageous for both desktop processors and mobile processors, however these solutions may be particularly disadvantageous for mobile processors because mobile processors are often restricted in size to small devices and restricted in power to the capacity of an attached battery.

Shortcomings mentioned here are only representative and are included simply to highlight that a need exists for improved electrical components, particularly for processors employed in consumer-level devices, such as mobile phones. Embodiments described herein address certain shortcomings but not necessarily each and every one described here or known in the art.

### SUMMARY

In certain embodiments, multiple data wordlengths may be supported by a processor through a single data path and/or a single set of registers. For example, the processor may have multiple modes, wherein each mode operates on data of a different word length. In one embodiment, the processor may have two modes: a first, low-precision mode for processing, e.g., 16-bit wordlengths, and a second, high-precision mode for processing, e.g., 24-bit wordlengths. In this embodiment, the processor may have registers and datapaths matching a widest wordlength, e.g., 24 bits.

Regardless of the number or operating modes, for supported data wordlengths that are less than the wordlength of the registers and datapath, the data may be left-aligned within the registers and datapath. The left alignment of data may allow saturation detection in the processor to be performed by examining the same saturation point regardless of the wordlength of the data being operated on. Thus, in the example embodiment above, a processor with 24-bit registers and datapaths may operate on high-precision data that occupies the entire wordlength of the register and data path, but when operating in low-precision mode left align the 16-bit data in the 24-bit registers and datapaths such that the least significant bits are zeros in low-precision mode. Power consumption in the processor may be reduced by left aligning the data and setting the least significant bits to zeros during operation in low-precision mode. Although left-alignment is described, the data may be either left-aligned or right-aligned, depending on operation of the processor, to align the low-precision data in more (or the most) significant bits.

In some embodiments, the processor may support a special saturation mode to set the lower bits to zero when a configuration register or instruction-bit is set. For example, an indication of operating mode may be received by the processor through a configuration register or bit in a received instruction. The processor may switch operating mode and process data based on the received indication. For example, the received indication may indicate to operate in either a second, high-precision mode (in which data has a second wordlength) or a first, low-precision mode (in which data has a first wordlength that is shorter than the second wordlength). In low-precision mode, the processor may set a certain number of lower bits of registers and datapaths to zero. Processing of data in the first mode and the second mode may use the same datapath within the processor. Further, when saturation is detected while operating in the low-precision mode, the processor may take steps to clear the least significant bits. In some embodiments, the processor may be configured to clear the least significant bits whenever certain operations are executed that may cause the least significant bits to be set. Thus, the least significant bits may remain zeros during low-precision mode operation to reduce power consumption in the processor.

Although processor operation is described herein, the term processor may refer to any logic device capable of saturation. For example, processor may refer to a central processing unit (CPU), a graphics processing unit (GPU), a digital signal processor (DSP), a microprocessor, an image processor, a co-processor, a network processor, and/or an audio processor. The processor may include one or more cores, wherein the cores may be identical or heterogeneous. Further, the processor may include other integrated functionality, such as dedicated video decoding, audio decoding, encryption circuitry, and/or peripheral bus interfaces.

According to one embodiment, an apparatus may include a processor capable of saturation and configured to process data in at least a low-precision mode and a high-precision mode, wherein a register size of the processor matches a data size in the high-precision mode. The processor may be configured to perform steps including processing the data as aligned to more significant bits, such when aligned as left-aligned data in some embodiments, in the low-precision mode and/or detecting saturation during the processing of the data, wherein the same saturation point is examined whether the processor is operating in the low-precision mode or the high-precision mode. In certain embodiments, the processor may be configured to process 16-bit data when the processor is operating in low-precision mode and to process 24-bit data when the processor is operating in high-precision mode. In certain embodiments, the processor may be a digital signal processor (DSP). In certain embodiments, the low-precision mode may be used to execute control applications, provide compatibility with code originally written for a different processor, and/or to process low-fidelity audio, and the high-precision mode may be used to execute high-precision arithmetic and/or process high-fidelity audio.

In some embodiments, the processor may be configured to perform steps including clearing one or more least significant bits (LSB) not in use during operation of the processor upon detecting saturation during the processing of data, clearing the one or more least significant bits (LSB) in hardware, clearing the one or more least significant bits (LSB) in response to a received instruction, and/or clearing one or more least significant bits (LSB) after pre-determined operations are performed during the processing of the low-precision data in the first mode. Certain other pre-determined operations may not involve the clearing of LSBs after execution. For example, add, subtract, and multiply operations involving input data with LSBs all set to zero will generally not result in results with LSBs set.

According to another embodiment, a method may include receiving an indication of whether data is low-precision data or high-precision data; processing the data as data aligned to more significant bits, such as data that is left-aligned data in some embodiments, in the low-precision mode; and/or detecting saturation during the processing of the data, wherein the same saturation point is examined whether the processor is operating in the low-precision mode or the high-precision mode. In some embodiments, the indication may be received by reading a configuration register of a processor. In certain embodiments, the low-precision mode processes 16-bit or 32-bit data and the high-precision mode processes 24-bit or 48-bit data.

In some embodiments, the method may further include clearing one or more least significant bits (LSB) upon detecting saturation during the processing of data, clearing the one or more least significant bits (LSB) in processor hardware, clearing the one or more least significant bits (LSB) in response to a received instruction, and/or clearing one or more least significant bits (LSB) after pre-determined operations are performed during the processing of the data. In certain embodiments, when operating in the low-precision mode, the digital signal processor processes 16-bit or 32-bit data and when operating in the high-precision mode the digital signal processor processes 24-bit or 48-bit data.

In certain embodiments, an apparatus may include a digital signal processor (DSP). The DSP may include multiply-accumulate circuitry that is configured to process data as data aligned to more significant bits, such as data that is left-aligned data in some embodiments, in the low-precision mode and/or detect saturation during the processing of the data, wherein the same saturation point is examined whether the processor is operating in the low-precision mode or the high-precision mode. In some embodiments, the multiply-accumulate circuitry may include a first set of registers, a multiplier coupled to the first set of registers and configured to receive two operands from the first set of registers, an adder coupled to the multiplier and configured to receive a result of a multiplication operation of the two received operands, and/or an accumulation register coupled to the adder and configured to accumulate value. The multiplier may be configured to operate on both low-precision data in low-precision mode and on high-precision data in high-precision mode.

In some embodiments, the DSP may also be configured to clear one or more least significant bits (LSB) upon detecting saturation during the processing of data, clear the one or more least significant bits (LSB) in processor hardware, clear the one or more least significant bits (LSB) in response to a received instruction, and/or clear one or more least significant bits (LSB) after pre-determined operations are performed during the processing of the data.

According to one embodiment, a computer program product may include a non-transitory computer readable medium having code for performing the steps of receiving an indication of whether data is low-precision data of a first wordlength or high-precision data of a second wordlength that is longer than the first wordlength; processing the data as data aligned to most significant bits in the low-precision mode; and/or detecting saturation during the processing of the data, wherein the same saturation point is examined whether the data is low-precision data or high-precision data.

According to another embodiment, a method of processing data of two different wordlengths in a processor with a single datapath that supports the two different wordlengths may include processing first data in a first mode having a first wordlength using a datapath of a processor; and/or processing second data in a second mode having a second wordlength that is longer than the first wordlength using the datapath of the processor. The step of processing the first data in the first mode may include processing the first data as data aligned to most significant bits of the datapath, such as when the first data is left-aligned in the datapath.

According to a further embodiment, an apparatus may include a processor comprising a datapath for processing data, wherein the processor processes first data of a first wordlength in a first mode using the datapath, and wherein the processor processes second data of a second wordlength longer than the first wordlength in a second mode using the datapath, and wherein the processor processes the first data in the first mode as data aligned to most significant bits of the datapath.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an example digital signal processor for processing data with different word lengths through two different data paths according to the prior art.

FIG. 2 is an example digital signal processor for processing data with different word lengths through a configurable data path according to the prior art.

FIG. 3 is an example digital signal processor for processing data with different word lengths through a single data path according to one embodiment of the disclosure.

FIG. 4 is an illustration of left-aligned 16-bit data and 24-bit with a common saturation point for processing in a digital signal processor according to one embodiment of the disclosure.

FIG. 5 is an example flow chart illustrating processing of data in a digital signal processor with two modes of operation according to one embodiment of the disclosure.

FIG. 6 is an example block diagram of a digital signal processor (DSP) multiply-accumulate circuitry for processing left-aligned data of variable data widths according to one embodiment of the disclosure.

FIG. 7 is an example mobile device with a processor for different width data from different applications according to one embodiment of the disclosure.

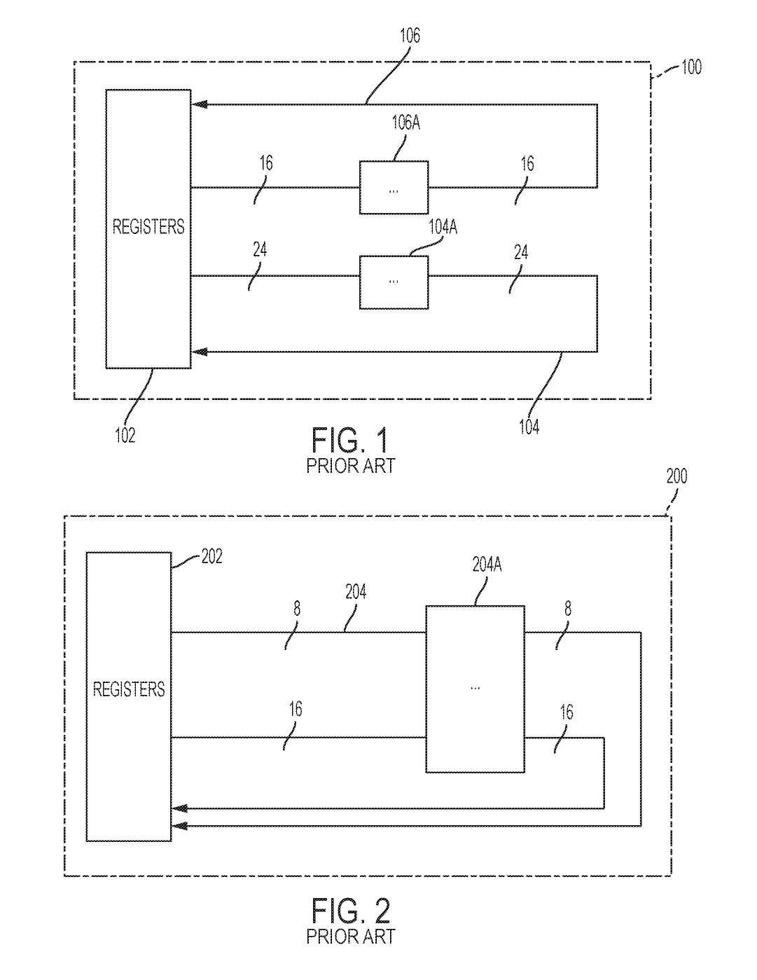

### DETAILED DESCRIPTION

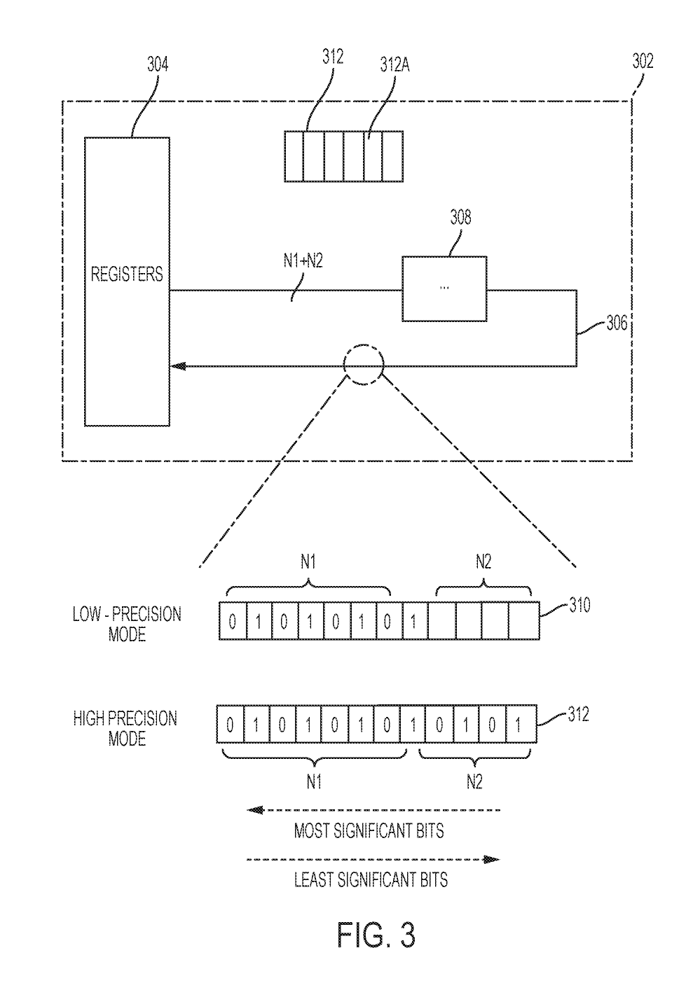

FIG. 3 is an example digital signal processor for processing data with different word lengths through a single data path according to one embodiment of the disclosure. A processor 302 may include registers 304 coupled to a datapath 306 through circuitry 308 that can read data from the registers 304, process the data, and write data to the registers 304. The datapath 306 may have a width large enough to support a largest wordlength of data for processing by the processor 302. In one embodiment, two operating modes may be supported as a low-precision mode and a high-precision mode. The low-precision mode may have a wordlength of N1 bits, and the high-precision mode may have a wordlength of N1+N2 bits. In these embodiments, the datapath 306 may have a width of N1+N2 bits. When the low-precision mode is 16-bits and the high-precision mode is 24-bits, the N1 value may be 16, the N2 value may be 8, and the width of datapath 306 may be 24 bits.

In a two-mode embodiment, data transmitted along the datapath 306 may be formatted as shown in data 310 and 312. Data 310 may illustrate low-precision data transmitted over datapath 306, and data 312 may illustrate high-precision data transmitted over datapath 306. “Higher bits” described herein may refer to bits of more significance, or bits that are left-aligned in a big endian computer system. “Lower bits” described herein may refer to bits of less significance, or bits that are right-aligned in a little endian computer system. The high-precision data 312 occupies all bits in the datapath 306. The low-precision data 310 occupies fewer than all bits in the datapath 306 and is left aligned, such that the data is stored in the most significant bits (MSBs) of the datapath 306, which leaves the least significant bits (LSBs) unused. Although blanks may be indicated in the N2 LSBs of data 310, in implementation zeroes may be located in these bits, and those zeroes would have no impact on the value being stored in the N1 MSBs. The least significant N2 bits may thus be set to zero during operation in low-precision mode as those bits do not impact the value represented by bits in the data 310. Setting these lower bits to zero may reduce power consumption by the circuitry 308 when processing the low-precision data. Further, setting these lower bits to zero may prevent propagation of bit toggles to higher bits that could cause arithmetic errors and higher power consumption. Although two-mode operation is described, the processor 302 may support additional modes of operation to support additional wordlengths.

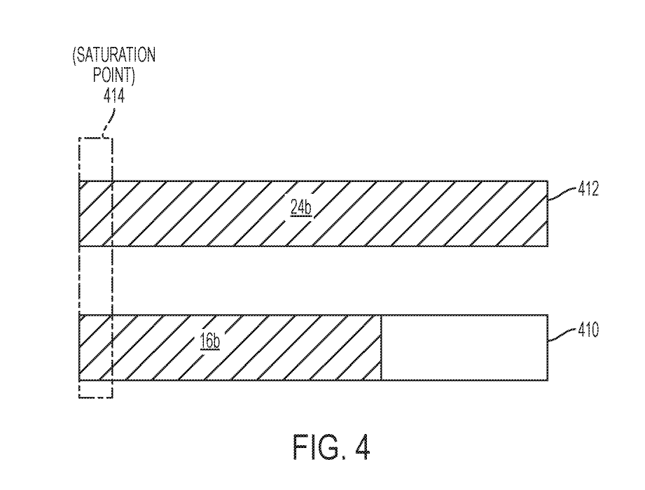

When operations are performed on values contained in the data, such as the low-precision data, the values may reach a saturation point, or reach a largest possible value that can be stored in a certain number of bits. Saturation may be detected by the processor and handled to prevent arithmetic errors, such as overflow. The left alignment of data may allow saturation detection in the processor to be performed by examining the same saturation point regardless of the wordlength of the data being operated on. FIG. 4 is an illustration of left-aligned 16-bit data and 24-bit with a common saturation point for processing in a digital signal processor according to one embodiment of the disclosure. FIG. 4 illustrates first data 412 with a wordlength of 24-bits in a 24-bit datapath occupying all bits of the datapath. Second data 410 with a wordlength of 16-bits may also be carried through the 24-bit datapath or stored in 24-bit registers in a left-aligned arrangement, in which data is stored in the most significant bits of the datapath or register. Thus, a common saturation point 414 may exist between the first data 412 and the second data 410. In some embodiments, the saturation point 414 may be one or more of the higher bits of the datapath or register and may provide an indication regarding saturation of either the first data 412 or the second data 410.

Referring back to FIG. 3, when operating in a mode of operation using less than all bits in the datapath 306, the processor 302 may be configured to handle saturation by setting the lower bits to zero regardless of whether saturation occurs. In some embodiments, the processor 302 may be further configured to reset lower bits to zero after certain predetermined operations. For example, right-shift operations may cause a set bit to shift from a higher bit into the lower bits. Thus, the processor 302 may be configured to set the lower N2 bits to zero after each right shift operation to ensure the lower N2 bits are not set.

One example of saturation detection is shown in the following source code that may be executed by the processor 302 for 16-bit and 24-bit modes of operation:

```
if ((in[24:23] == 2’b00) || (in[24:23] == 2’b11))
  out[23:0] = in[23:0]
else
  if (in < 0) out = 0x800000;
  else
    if (S16) out = 0x7FFF00;
    else out = 0x7FFFFF;
```

In the example above, “in” and “out” may denote memory locations 24 bits in width, such as one of the registers 304, and “S16 ” may denote a configuration bit, such as bit 312A, indicating a mode of operation for the processor 302. In the code above, when saturation is detected, the configuration bit S16 is examined, and if the S16 bit is set indicating 16-bit mode of operation, then the memory location is saturated such that the low bits remain zero. If saturation is detected and the configuration bit S16 is not set (indicating 24-bit mode of operation), then the memory location is saturated with all bits set to one. Example input values to the code above are listed in Table 1 below along with the corresponding output of the code.

TABLE 1

| In Value | Out Value | Notes |
|---|---|---|
| 0x0876543 | 0x7FFFFF | Positive saturation detected with S16 = 0 |
| 0x100AAAA | 0x800000 | Negative saturation detected with S16 = 0 |
| 0x0654321 | 0x654321 | No saturation detected |
| 0x08765 | 0x7FFF00 | Positive saturation detected with S16 = 1 |

Another example of saturation detection is shown in the following source code that may be executed by the processor 302 for 32-bit and 48-bit modes of operation:

```
if ((in[55:47] == 9’d0) || (in[55:47] == 9’b111111111))
  out[47:0] = in[47:0];
else
  if (in <0) out = 0x800000000000;
else
  if (S32) out = 0x7FFFFFFF0000;
  else out = 0x7FFFFFFFFFFF;
```

Example input values to the code above are listed in Table 2 below along with the corresponding output of the code.

TABLE 2

| In Value | Out Value | Notes |
|---|---|---|
| 0x12345678ABCDEF | 0x7FFFFFFFFFF | Positive saturation |
| | | detected with S32 = 0 |
| 0xCCBBBBBBAAAAAA | Ox800000000000 | Negative saturation |
| | | detected with S32 = 0 |
| 0xFF876543210ABC | 0x876543210ABC | No saturation detected |
| 0x12345678ABCDEF | 0x7FFFFFFF0000 | Positive saturation |
| | | detected with S32 = 1 |

The processor 302 may determine the appropriate mode of operation by receiving information from an application executing on the processor 302. In one embodiment, the processor 302 may include a configuration register 312, in which one configuration bit 312A, may be set to zero or one to toggle the processor 302 between two modes of operation. In processors with more than two modes of operation, additional bits may be used in the configuration register 312 to indicate which of multiple modes of operation should be executed. The configuration bit 312A may be set during execution of an application. In another embodiment, the processor 302 may implement different instructions for operations in different modes of operations. For example, the processor 302 may receive a “MULT1” operation instructing execution of multiplication in a first mode of operation, such as multiplying two 16-bit values, and may receive a “MULT2” operation instructing execution of multiplication in a second mode of operation, such as multiplying two 24-bit values.

The registers 304 may be configured to support the multiple possible wordlengths in different modes of operation. For example, the registers 304 may have a wordlength matching the width of datapath 306, which is the largest wordlength of the various modes of operation possible within processor 300. For example, when the two modes of operation are 16-bit and 24-bit, the registers 304 may have a wordlength of 24-bit. Low-precision values may be packed into the 24-bit registers. By storing multiple wordlengths of data in the registers 304, the processor may include less circuitry and thus support a greater maximum clock speed and subsequent speed of operation.

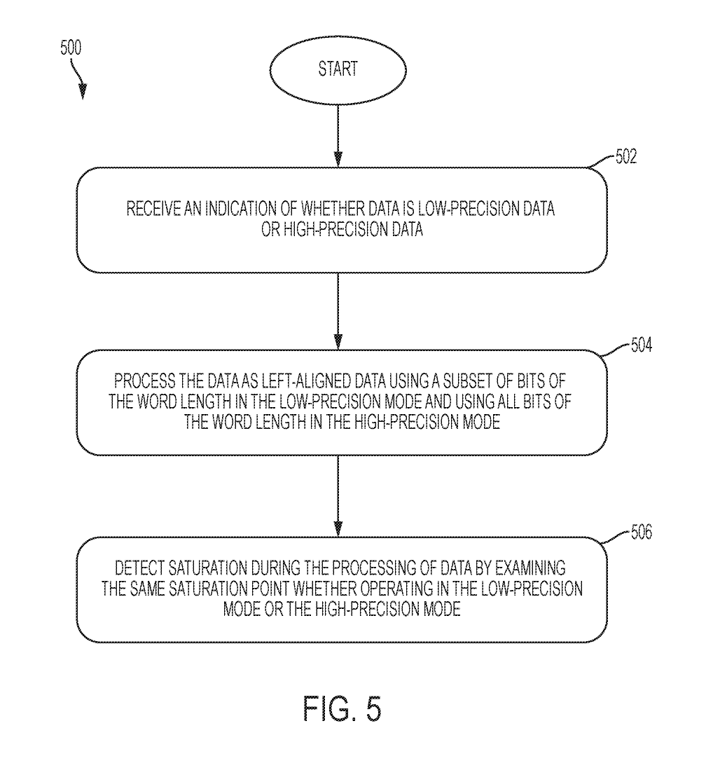

A method of operating a processor to support multiple modes of operation is shown in FIG. 5. FIG. 5 is an example flow chart illustrating processing of data in a digital signal processor with two modes of operation according to one embodiment of the disclosure. A method 500 may begin at block 502 with receiving an indication of whether the processor is operating in a first mode of operation, such as a low-precision mode, or in a second mode of operation, such as a high-precision mode. The indication may be received, for example, through a configuration register or as part of an instruction. Next, at block 504, the processor may process data retrieved from the registers in the first mode as left-aligned data using a subset of the bits and in the second mode using all bits. Then, at block 506, the processor may detect saturation during the processing of data by examining the same saturation point whether in a first mode of operation or the second mode of operation. When saturation is detected at block 506, the lower bits may be set to zero when the received indication of block 502 indicates operation of the processor in the first mode of operation. In one embodiment, the setting of the lower bits may be performed in hardware by the processor without instruction from an application executing on the processor. In another embodiment, the saturation may be determined by the software executing on the processor and/or the lower bits may be set by the processor in response to an instruction received from the application.

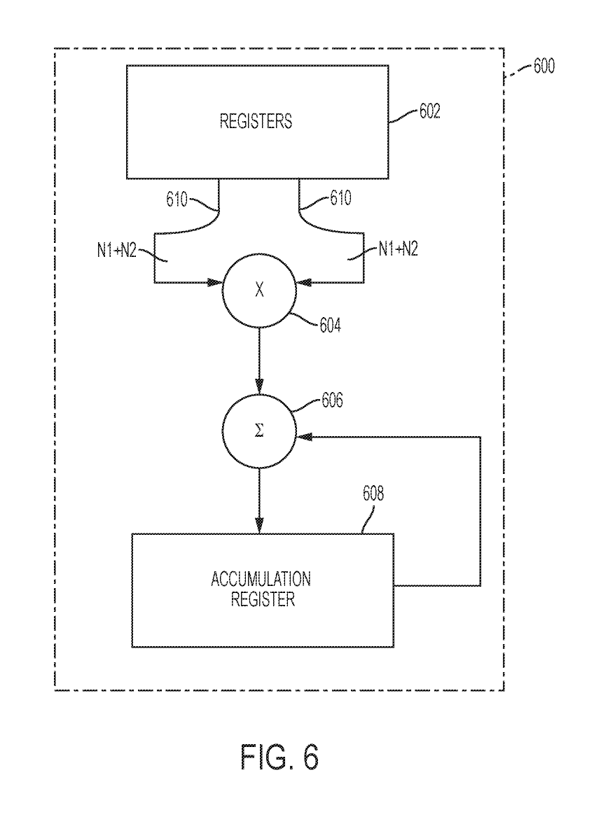

One operation that may be performed by the processor in block 504 of FIG. 5 is a multiply-accumulate operation. The processor 302 of FIG. 3 may include circuitry in circuitry 308 for performing multiply-accumulate operations, and one example of such a circuit is shown in FIG. 6. FIG. 6 is an example block diagram of a digital signal processor (DSP) multiply-accumulate circuitry for processing left-aligned data of variable data widths according to one embodiment of the disclosure. A circuit 600, which may be included in a processor, may include registers 602 from which two values may be retrieved and loaded into a multiplier 604 as operands. The multiplier 604 may multiply the two operands to obtain a result, and that result passed to summing block 606. The same multiplier 604 may be used to perform multiplication regardless of the mode of operation. That is, in one embodiment, the same multiplier 604 may be used for performing 16-bit multiplication or 24-bit multiplication. The summing block 606 may receive a running value from an accumulation register 608 and add to the running value the result of the multiplication at multiplier 604. The sum of the running value and the new multiplication result may then be stored back in the accumulation register 608. The circuit 600 may thus implement an arithmetic operation described as:

a+(b×c)→a,

where a is the value stored in the accumulation register 608, and b and c are operands retrieved from the registers 602 through datapath 610. The multiply-accumulate (MAC) operation described with reference to FIG. 6 may be commonly performed in signal processing operations such as to calculate dot products and results of matrix multiplications.

In one embodiment, the multiplier 604 may process data received through datapath 610 similarly regardless of the wordlength of the data. For example, when 24-bit data is received, the multiplier 604 may multiply the operands to obtain a result, and when 16-bit data is received having all lower bits set to zero, the multiplier 604 may similarly multiply the operands to obtain a result. In contrast, conventional multipliers may divide operands into pieces and perform multiplication of the various pieces of the words and sum the words together. For example, a conventional multiplier may divide a 24-bit word into a 16-bit portion and an 8-bit portion, perform multiplication using the 16-bit portion and 8-bit portions separately and sum the results. This division allows the multiplier to be capable of supporting 16-bit arithmetic when the conventional multiplier receives a 16-bit word instead of a 24-bit word. In some embodiments, the multiplier 604 may not divide operands into portions when performing multiplication or other arithmetic operations.

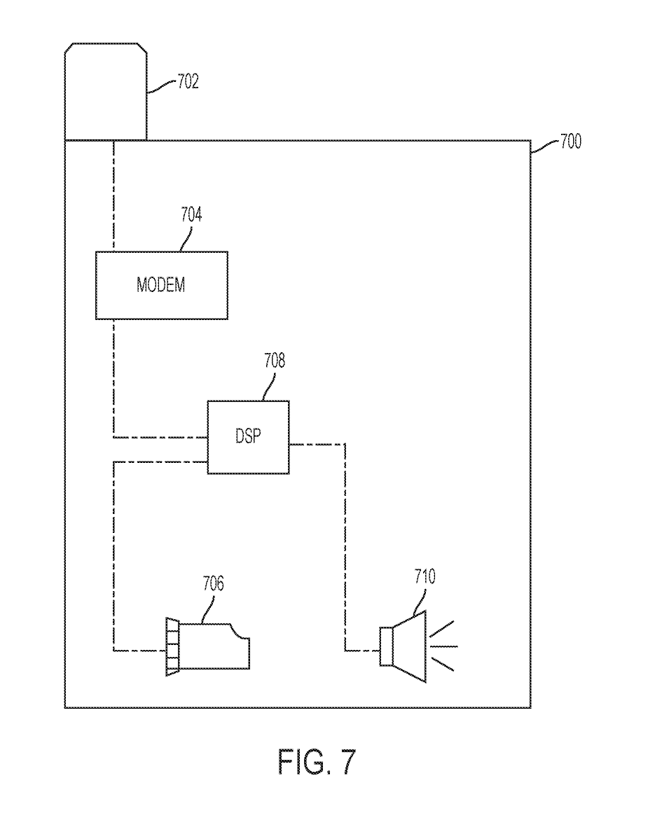

The processor embodiments described above may be useful in any computing device to reduce power consumption, reduce heat dissipation, decrease size, and reduce cost. One particularly advantageous embodiment may include the integrating of the processor described in various embodiments above in a mobile device. FIG. 7 is an example mobile device with a processor for different width data from different applications according to one embodiment of the disclosure. A mobile device 700 may be, for example, a portable media player, a cellular phone, an MP3 player, a tablet, or a laptop computer. In some embodiments, the mobile device 700 may include a wireless antenna 702 for transmitting and receiving data, such as voice communications. The voice communications may be processed, in part, by a modem 704, and voice data transmitted to digital signal processor (DSP) 708. The DSP 708 may also receive data from an internal memory 706, such as random access memory (RAM) or a memory card, which may include music audio data. The voice data may be 16-bit data, and the music data may be 24-bit data. The different wordlengths may be a result of different fidelities of the voice data and the music data, in which the voice data is of lower fidelity than the music data. The DSP 708 may implement a single datapath for processing the 16-bit and 24-bit data as described in embodiments above. Further, the DSP 708 may implement saturation detection, configuration registers, and/or multiply-accumulate circuitry such as described in embodiments above. The mobile device 700 may have extended battery life and a smaller form factor as a result of the advantages of having a processor, such as DSP 708, with a single datapath for operating in multiple modes of operation with different wordlengths.

The schematic flow chart diagram of FIG. 5 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although digital signal processors (DSPs) are described throughout the detailed description, aspects of the invention may be applied to the design of other processors, such as graphics processing units (GPUs) and central processing units (CPUs). Further, although ones (1s) and zeros (0s) are given as example bit values throughout the description, the function of ones and zeros may be reversed without change in operation of the processor described in embodiments above. For example, a one value in a configuration register may be used to indicate either a first mode of operation or a second mode of operation without change in the operation of the processor. Additionally, although 16-bit and 24-bit modes are described for a processor, the processor may support different wordlengths and/or additional wordlengths. For example, a processor may support 32-bit wordlength as a low-precision mode and 48-bit wordlength as a high-precision mode. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An apparatus, comprising:
a processor capable of saturation and configured to process data in at least a first mode for processing data of a first wordlength and a second mode for processing data of a second wordlength that is longer than the first wordlength, wherein a register size of the processor matches the second wordlength, and wherein the processor is further configured to perform steps comprising:
processing the data as data aligned to the most significant bits of registers of the processor in the low-precision mode; and
detecting saturation during the processing of the data, wherein the same saturation point is examined whether the processor is operating in the low-precision mode or the high-precision mode.

2. The apparatus of claim 1, wherein the processor is configured to process the data aligned to the most significant bits as left-aligned data.

3. The apparatus of claim 1, wherein the processor is further configured to perform steps comprising clearing one or more least significant bits (LSB) not in use during operation of the processor in the first mode upon detecting saturation during the processing of data in the first mode.

4. The apparatus of claim 3, wherein the processor performs the step of clearing the one or more least significant bits (LSB) in hardware.

5. The apparatus of claim 3, wherein the processor performs the step of clearing the one or more least significant bits (LSB) in response to a received instruction.

6. The apparatus of claim 1, wherein the processor is further configured to perform steps comprising clearing one or more least significant bits (LSB) not in use during operation of the processor in the first mode after pre-determined operations are performed during the processing of the data, wherein the pre-determined operations may cause least significant bits (LSBs) to be set during the processing of the data in the first mode.

7. The apparatus of claim 1, wherein the processor is configured to process 16-bit data when the processor is operating in low-precision mode, and wherein the processor is configured to process 24-bit data when the processor is operating in high-precision mode.

8. The apparatus of claim 1, wherein the processor comprises a digital signal processor (DSP).

9. A method, comprising:
receiving, at a processor having a register size of a second wordlength, an indication of whether data is low-precision data of a first wordlength or high-precision data of the second wordlength that is longer than the first wordlength;
processing, by the processor, the data as data aligned to most significant bits in registers of the processor in the low-precision mode; and
detecting, by the processor, saturation during the processing of the data, wherein the same saturation point is examined whether the data is low-precision data or high-precision data.

10. The method of claim 9, wherein the step of processing the data as data aligned to the most significant bits comprises processing the data as left-aligned data.

11. The method of claim 9, further comprising clearing one or more least significant bits (LSB) not in use during operation of the processor on low-precision data upon detecting saturation during the processing of the low-precision data.

12. The method of claim 11, wherein the step of clearing the one or more least significant bits (LSB) is performed in processor hardware.

13. The method of claim 11, wherein the step of clearing the one or more least significant bits (LSB) is in response to a received instruction.

14. The method of claim 9, further comprising clearing one or more least significant bits (LSB) not in use during operation of the processor on the low-precision data after pre-determined operations are performed during the processing of the data, wherein the pre-determined operations may cause least significant bits (LSBs) to be set during the processing of the low-precision data.

15. The method of claim 9, wherein the low-precision data comprises 16-bit data, and wherein the high-precision data comprises 24-bit data.

16. The method of claim 9, wherein the step of receiving an indication of whether data is low-precision data or high-precision data comprises reading a configuration register of a processor.

17. An apparatus, comprising:
a digital signal processor (DSP) configured to process data with a first wordlength in a first mode and to process data with a second wordlength longer than the first wordlength in a second mode, wherein a register size of the digital signal processor (DSP) matches the second wordlength, the digital signal processor (DSP) configured to perform steps comprising:
processing data aligned to most significant bits of registers of the digital signal processor (DSP) in the first mode; and
detecting saturation during the processing of the data in the first mode, wherein the same saturation point is examined whether the processor is operating in the first mode or the second mode.

18. The apparatus of claim 17, wherein the digital signal processor (DSP) comprises multiply-accumulate circuitry configured to perform the steps of processing the data and detecting the saturation.

19. The apparatus of claim 18, wherein the multiply-accumulate circuitry is configured to process data aligned to more significant bits by processing left-aligned data.

20. The apparatus of claim 18, wherein the multiply-accumulate circuitry comprises:
a first set of registers;
a multiplier coupled to the first set of registers and configured to receive two operands from the first set of registers;
an adder coupled to the multiplier and configured to receive a result of a multiplication operation of the two received operands; and
an accumulation register coupled to the adder and configured to accumulate value.

21. The apparatus of claim 20, wherein the multiplier is configured to operate on both low-precision data in the first mode and on high-precision data in the second mode.

22. The apparatus of claim 17, wherein when operating in the first mode, the digital signal processor processes 16-bit data, and wherein when operating in the second mode, the digital signal processor processes 24-bit data.

23. The apparatus of claim 17, wherein the digital signal processor is further configured to perform steps comprising clearing one or more least significant bits (LSB) not in use during operation of the processor in the first mode upon detecting saturation during the processing of data in the first mode.

24. The apparatus of claim 17, wherein the processor is further configured to perform steps comprising clearing one or more least significant bits (LSB) not in use during operation of the processor in the first mode after pre-determined operations are performed during the processing of the data in the first mode, wherein the pre-determined operations may cause least significant bits (LSBs) to be set during the processing of the data.

25. A computer program product, comprising:
a non-transitory computer readable medium comprising code for performing steps comprising:
receiving an indication of whether data is low-precision data of a first wordlength or high-precision data of a second wordlength that is longer than the first wordlength;
processing the data as data aligned to most significant bits in the low-precision mode; and
detecting saturation during the processing of the data, wherein the same saturation point is examined whether the data is low-precision data or high-precision data.

26. The computer program product of claim 25, wherein the step of processing the data as data aligned to the most significant bits comprises processing the data as left-aligned data.

27. The computer program product of claim 25, wherein the medium further comprises code to perform a step of clearing one or more least significant bits (LSB) not in use during operation of the processor on low-precision data upon detecting saturation during the processing of the low-precision data.

28. The computer program product of claim 25, wherein the medium further comprises code to perform a step of clearing one or more least significant bits (LSB) not in use during operation of the processor on the low-precision data after pre-determined operations are performed during the processing of the data, wherein the pre-determined operations may cause least significant bits (LSBs) to be set during the processing of the low-precision data.

29. The computer program product of claim 25, wherein the low-precision data comprises 16-bit data, and wherein the high-precision data comprises 24-bit data.

30. The computer program product of claim 25, wherein the step of receiving an indication of whether data is low-precision data or high-precision data comprises reading a configuration register of a processor.

31. A method, comprising:
processing first data in a first mode having a first wordlength using a datapath of a processor; and
processing second data in a second mode having a second wordlength that is longer than the first wordlength using the datapath of the processor,
wherein the step of processing the first data in the first mode comprises processing the first data as data aligned to most significant bits of the datapath.

32. The method of claim 31, wherein the step of processing the first data in the first mode comprises processing the first data as left-aligned data.

33. The method of claim 31, wherein the step of processing the first data in the first mode comprises clearing one or more least significant bits (LSB) not in use during processing the first data upon detecting saturation during the processing of the first data.

34. The method of claim 31, wherein the step of processing the first data in the first mode comprises clearing one or more least significant bits (LSB) not in use during operation of the processor in the first mode after pre-determined operations are performed during the processing of the first data, wherein the pre-determined operations may cause least significant bits (LSBs) to be set during the processing of the first data.

35. The method of claim 31, wherein the first data comprise 16-bit words, and wherein the second data comprises 24-bit words.

36. An apparatus, comprising:
a processor comprising a datapath for processing data,
wherein the processor processes first data of a first wordlength in a first mode using the datapath, and wherein the processor processes second data of a second wordlength longer than the first wordlength in a second mode using the datapath, and
wherein the processor processes the first data in the first mode as data aligned to most significant bits of the datapath.

37. The apparatus of claim 36, wherein the processor is configured to process the first data in the first mode by processing the first data as left-aligned data.

38. The apparatus of claim 36, wherein the processor processes the first data in the first mode by clearing one or more least significant bits (LSB) not in use during the processing of the first data upon detecting saturation during the processing of the first data.

39. The apparatus of claim 36, wherein the processor processes the first data in the first mode by clearing one or more least significant bits (LSB) not in use during processing the first data after pre-determined operations are performed during the processing of the first data, wherein the pre-determined operations may cause least significant bits (LSBs) to be set during the processing of the first data.

40. The apparatus of claim 36, wherein the first data comprise 16-bit words, and wherein the second data comprises 24-bit words.
